(19) United States
(12) Patent Application Publication
(10) Pub. No.: US 2017/0231729 A1
(43) Pub. Date: Aug. 17, 2017

(54) ABUTMENT TOOL SET AND DEVICE FOR PRODUCING TOOTH REPLACEMENTS

(71) Applicant: Ivoclar Vivadent AG, Schaan (LI)

(72) Inventors: Goran Burger, Grabs (CH); Arnd Peschke, Planken (LI)

(21) Appl. No.: 15/502,812

(22) PCT Filed: Nov. 13, 2015
(86) PCT No.: PCT/EP2015/076545

§ 371 Date: Feb. 9, 2017

(30) Foreign Application Priority Data
Nov. 14, 2014 (EP) 14193336.6

(51) Int. Cl. A61C 13/00; A61C 13/12; B23C 5/00; A61C 8/00

(52) U.S. Cl. CPC A61C 13/0006; A61C 8/0066; A61C 13/0004; A61C 8/0012; A61C 13/12; B23C 5/006; B23C 2226/18

(57) ABSTRACT

Device for producing tooth replacements, which device has a milling cutter (36) for shaping the front face of the tube portion (16), which milling cutter (36) has at least one abutment face which is intended to bear at least indirectly on a surface of the abutment (10), in particular on the collar (14) of the abutment, and via which milling cutter (36) the length or height of the tube portion (16) of the abutment (10) can be fixed, in particular the tube portion can be shaped. Tool set consisting of a milling cutter (36) and of a sleeve (42), wherein at least one abutment face (76) is formed on the milling cutter and extends towards the sleeve (42), and wherein the sleeve (42) has a supporting face (78), in particular for supporting on an abutment (10).

The invention relates to an abutment tool set and a device for producing dental replacements according to the preamble of claim 1 and 10, respectively.

Implant-based dental restorations have been used on a large scale and for several decades. The basis is always an implant which is fixedly connected with the jawbone of a patient, usually by means of a screwed connection.

For providing the actual dental restoration it has proven to be appropriate to use a meso-structure which is referred to as an abutment, which typically consists of a metal such as titanium, but which can also consist of high-strength oxide ceramics, and which serves as a connection element to the suprastructure which consists of a glass ceramic or a feldspar ceramic in most cases.

The requirements to a dental restoration produced in this way are significant: Durability is an important acceptance criterion, also under high alternative loading, and aesthetics is also particularly important.

The dental restoration is to have a translucent appearance, similar to natural teeth. As a matter of face, this does not only hold true for individual teeth but also for bridges and the like.

Slightly older examples of solutions of this kind are apparent from DE 32 41 963 C1 or GB 2 119 258. For more recent solutions comprising an anti-rotation mechanism it is referred to U.S. Pat. No. 5,782,918 A1.

For reasons of a more simple storage but also to exclude liability cases reliably, an abutment of one single size is typically stored. This abutment is sufficient for first molars and second molars, and also absorbs the shearing forces acting thereat. This requires a certain, not insignificant height of the tube portion of the abutment via which the abutment protrudes into the suprastructure.

If the same abutment is to be used for a canine tooth or incisor tooth restoration, at least the aesthetical result would be unsatisfactory, as the metallic tube portion would then be visible through the glass ceramic of the suprastructure, leading to an aesthetically unsatisfactory overall impression.

Thus, attempts have been made to prevent the metallic abutment from shining through by means of a so-called opaquer. But still there is the problem of the comparatively small wall thickness of the suprastructure with standard abutments.

This problem is well known to dental technicians and in particular to dentists. In order to prevent any complaints by the patients in advance, dentists often shorten the tube portion without further ado and against the provisions issued by the manufacturers of the abutments, for instance by means of a simple cutting wheel in order to prevent the tube portion from projecting into thin areas of the suprastructure.

In this way, the primary acceptance of dental restorations of this type is increased with the patients. Surprisingly, however, this solution brings along complaints with respect to durability which lead to the fact that the dental technician or dentist has to replace the dental restoration within a comparatively short period of time or is even having recourse against him.

Thus, the invention is based on the task of providing an abutment tool set and a device for producing dental replacements according to the preamble of claim 1 and 10, respectively, which enables improved long-term acceptance of implant-based dental restorations.

This task is inventively solved by claims 1 and 10. Advantageous further developments may be taken from the subclaims.

According to the invention it is particularly favorable that by means of a milling cutter with a simple construction a long-term compatible shortening of the tube portion of the abutment can be realized surprisingly. For this purpose, the milling cutter comprises a height stop which enables precise orientation on the one hand, for instance by the height stop resting on the collar of the abutment, and on the other hand enables predefined height dimensions for the tube portion.

In this way, for instance, the implant can be determined with regard to the height in predefined grid dimensions, for instance in the three heights S, M and L.

For this purpose, it can be provided, for instance, to mark the tube portion for the height M at height dimensions of 4.2 mm. In this case, the height dimensions are calculated from the bearing region at the collar of the abutment. By means of a micro angle grinder the tube portion can be cut off to 4.2 mm. By means of the inventive abutment tool set comprising the milling cutter the height of the tube portion is then cut to 4 mm and at the same time the tube portion is provided with a radius at the corners. A radius of this type is important in order to minimize the notch effects of the abutment with regard to the suprastructure of the dental restoration part and can now be ensured reliably in a surprisingly simple manner according to the invention.

In this connection, the inventive abutment tool set basically serves as a shaping tool and not to actually shorten the tube portion.

The inventive milling cutter can be configured as a manual milling cutter. Alternatively, it can be clamped in a milling machine known per se as a tool. For this purpose, it comprises an appropriately configured shank with a clamping or actuation area and a transition area which is thicker in comparison.

By attaching a radius or at least one slope it is ensured that durability is guaranteed. Attempts have shown that the durability of tube portions which have been shortened by means of the inventive auxiliary element is improved considerably, surprisingly; compared to tube portions which have been shortened by means of a hand saw. In this connection, it is particularly favorable that the attachment of the radius or the fillet of the tube portion on the outside can reduce or even avoid completely the introduction of notch effect forces into the suprastructure.

By automatically orienting the front face of the tube portion in parallel with the collar, orientation mistakes are avoided reliably which could lead to an inclination of the suprastructure, and thus also problem zones in the occlusal position of the dental replacement which would then require postprocessing—if they are removed after all.

According to the invention, the milling cutter can be used easily when a dental restoration is to be produced which is smaller or at least not as high as the maximum size. According to the invention, the height of the tube portion is determined for this purpose, for instance to the height of 4 mm=S or 5 mm=M. The height is determined such that the wall thickness to the occlusal surface is not smaller than predefined minimum dimensions. These minimum dimensions can be determined to be 2 mm or for instance also 1.5 mm. The shortening process can be effected by clamping the auxiliary element configured as a milling cutter in a dental handpiece which is available anyways. The abutment which is also fixed is then milled to correspond exactly to the predefined dimensions of, for instance, a tube portion height of 4 mm, wherein the speed of the dental handpiece can typically amount to 5000 to 15000, or even to 50000, revolutions per minute.

In an alternative embodiment, the milling cutter is prepared to realize marks. For this purpose, by means of the milling cutter the desired mark is made at a height of, for instance, 4 mm, and the desired height is then adjusted by means of a milling cutter known per se. Subsequently, the dental handpiece is used again for the realization of the desired fillets or radii, and post-processing is performed by manually turning the milling cutter which ensures the exact desired shape of the front face of the tube portion.

In both cases, there is the special advantage that an exactly post-processable and predefined surface configuration can be realized in the area of the front face of the tube portion.

Even if realizing a fillet or a radius at the outer circumference of the front face is particularly important according to the invention, it is to be understood that there is nothing wrong with effecting a corresponding fillet at the radially inner end of the front face of the tube portion.

Besides the exact shaping and thus reproducibility, at the same time on the inside and on the outside of the front face flash-removal and trimming can be ensured after the defined shortening of the height of the tube portion.

If anti-rotation elements are provided at the mesostructure, namely the abutment, and at the suprastructure, namely the ceramic dental restoration, they remain fully operative even after the height correction has been effected by the inventive auxiliary element.

According to the invention, it is also favorable if the inventive height modification tool is involved in the automatic CAD/CAM production of the dental restoration. For this purpose, it can be determined, for instance, in the design phase that the maximum height of the suprastructure, calculated from the collar of the abutment, is to be two times as high as the tube portion as an upper boundary condition, and that the wall thickness to the occlusal face is to amount to at least 1.5 mm as a lower boundary condition.

Then, the CAD software decides on the required use of the inventive height modification tool, which is configured as an abutment tool set, in the predefined grid dimensions, and at the same time predetermines the latter. It is to be understood that in case of different diameters of implants and abutments—and thus also different diameters of the associated tube portions—the tool may have a diameter adapted thereto, respectively.

It is also possible, and particularly favorable according to the invention, if the abutment tool set comprises an integrated height stop which becomes effective in machining just when the target height is achieved. For this purpose, the height stop is configured preferably rotationally symmetrically. For instance, it can be configured as a pin which rests on the implant screw whose screw head extends along the base of the tube portion, or as a sleeve which is supported on the collar of the abutment.

When the height stop is configured as a sleeve, the milling cutter is supported on the upper part of the sleeve. For this purpose, it comprises a step between the actual work portion at which the cutting edges of the milling cutter are configured and a transition area which forms an abutment face on the sleeve. This embodiment ensures that the exact desired height of the tube portion of the abutment is achieved, measured from the collar of the abutment.

It is also possible to combine these height stops.

As the screw heads of the implant screws are typically not standardized and thus comprise a different thickness, the selection of the collar of the abutment as a reference is preferred.

According to the invention it is particularly favorable if the sleeve comprises guide elements which are intended to abut on the tube portion of the abutment in a rotationally symmetrical manner. In this way, precise guidance between sleeve and abutment is ensured in an axially parallel manner. The guide elements can extend either along the inner face of the tube portion or along the outer face of the tube portion, or along both, if required.

In a further advantageous embodiment it is provided that the sleeve comprises at least one chip removal recess. The chip removal recess extends preferably circularly through the outer wall of the sleeve, that is to say the wall of the sleeve, and/or adjacent to the front area of the tube portion, and serves to carry off chips which are produced when the front face of the tube portion is machined to the outside. Accordingly, these recesses are open towards the outside and are slanted slightly to make chip removal easier.

The chip removal recesses can be configured in any desired appropriate manner, for instance, obliquely relative to the rotational axis, following the chip removal direction.

In an advantageous embodiment it is provided that the height determination of the tube portion of the abutment is carried out in coordination with available press-ceramic auxiliary parts which can be fired-out. They serve to determine the thickness of an adhesive gap precisely and uniformly according to material-specific aspects, wherein the predefined and standardized length of the tube portion at the same time provides for predefined and standardized adhesive surfaces, such that the risk of an improper adhesion is reduced.

Preferably, the tube portion comprises a slightly conical contour on the outside, having a cone angle of between 0.5° and 8°. The same holds true for the matching inner surface of a sleeve of the auxiliary element such that it also extends at a hollow cone angle of between 0.5° and 8°.

In an advantageous embodiment, it is provided that by means of the abutment tool set the tube portion may be shortened to the patient-specific height in a machining process, in particular by means of a dental milling device and/or a CAM device.

In a further advantageous embodiment, it is provided that a central pin of the abutment tool set is provided which is intended to abut on the head of a screw which passes through the abutment at least partially.

In a further advantageous embodiment, it is provided that the abutment tool set comprises a central pin which is molded to a front area of a bell-shaped element of the abutment tool set in particular integrally, said pin extending through the bell-shaped element, in particular projecting beyond the latter.

In a further advantageous embodiment, it is provided that the abutment tool set comprises an in particular rasterized height stop which is intended to abut on the abutment, said height stop being positioned in a predefined relative position to the front face of the tube portion.

In a further advantageous embodiment, it is provided that the abutment tool set comprises a cutting tool, in particular a manual milling cutter, for shortening the tube portion, said manual milling cutter being guided by the bell-shaped element.

In a further advantageous embodiment, it is provided that a front face of the bell-shaped element of the abutment tool set comprises in particular staggered teeth or single-edged teeth which are intended to shorten the tube portion of the abutment.

In a further advantageous embodiment, it is provided that the abutment tool set comprises a marker which is capable of attaching at least one mark at the abutment, said mark indicating a shortening of the tube portion of the auxiliary element.

In a further advantageous embodiment, it is provided that the indication of the shortening takes place in predefined grid dimensions, in particular in 3 heights, depending on the size in particular of the vertical extension of the suprastructure which forms part of the dental restoration.

In a further advantageous embodiment, it is provided that in the front area of a bell-shaped element of the abutment tool set an annular concave profile with a fillet is provided for the machining process of the front face of the tube portion of the abutment with a matching convex shape.

In a further advantageous embodiment, it is provided that the abutment tool set comprises a height stop element which extends with an internal diameter outside of the tube portion of the abutment which is larger than or equal to the external diameter of the tube portion and which is intended to bear against the collar of the abutment to provide for a height stop.

In a further advantageous embodiment, it is provided that the height stop element extends in a clearance fit to the tube portion of the abutment and in this connection particularly enables rotation of the abutment tool set with the height stop element relative to the abutment.

In a further advantageous embodiment, it is provided that the auxiliary element comprises a bell-shaped element whose open free end comprises a circumferential edge which serves as a height stop element, particularly with respect to a bearing surface of the collar of the abutment.

Further advantageous details and features may be taken from the following description of several exemplary embodiments of the invention in conjunction with the drawings, in which:

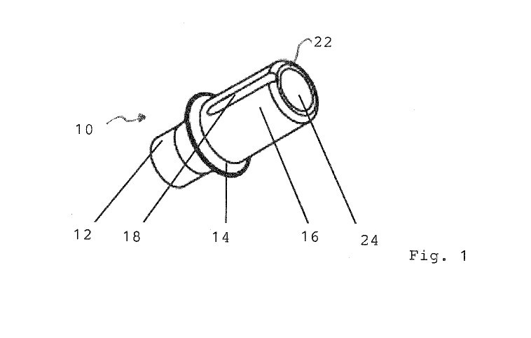

FIG. 1 shows a schematic view through an abutment of an inventive device for producing dental replacements;

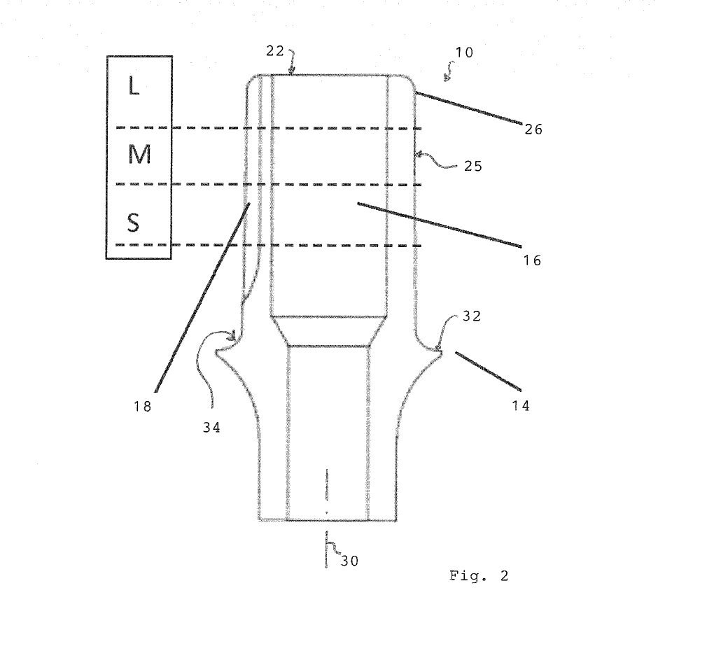

FIG. 2 shows a schematic sectional view through the abutment of FIG. 1;

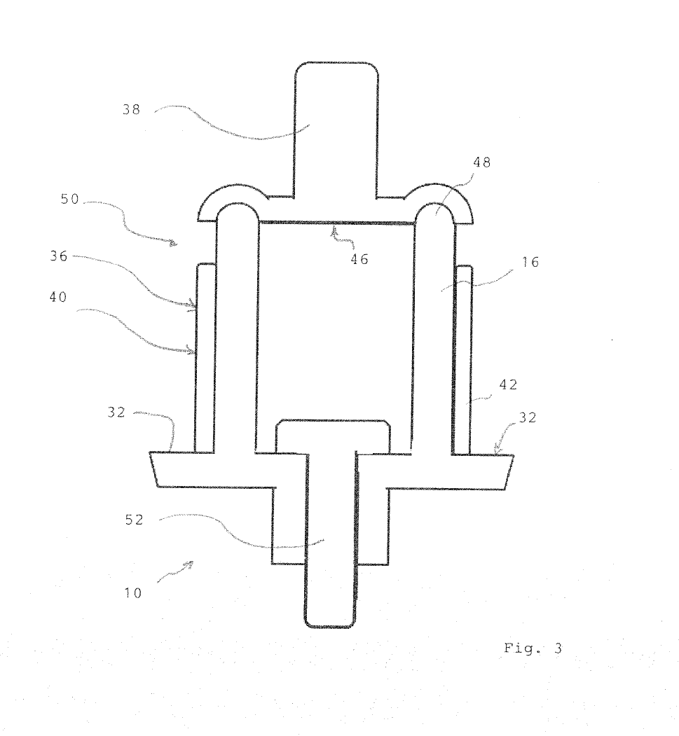

FIG. 3 shows a schematic sectional view through an abutment tool set of an inventive device for producing dental replacements, additionally illustrating the abutment and the implant screw;

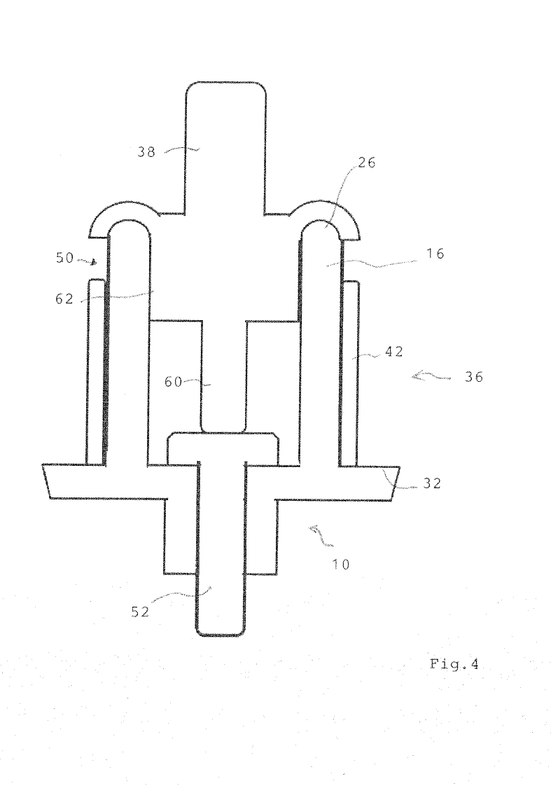

FIG. 4 shows a further embodiment of the abutment tool set, in an illustration according to FIG. 3;

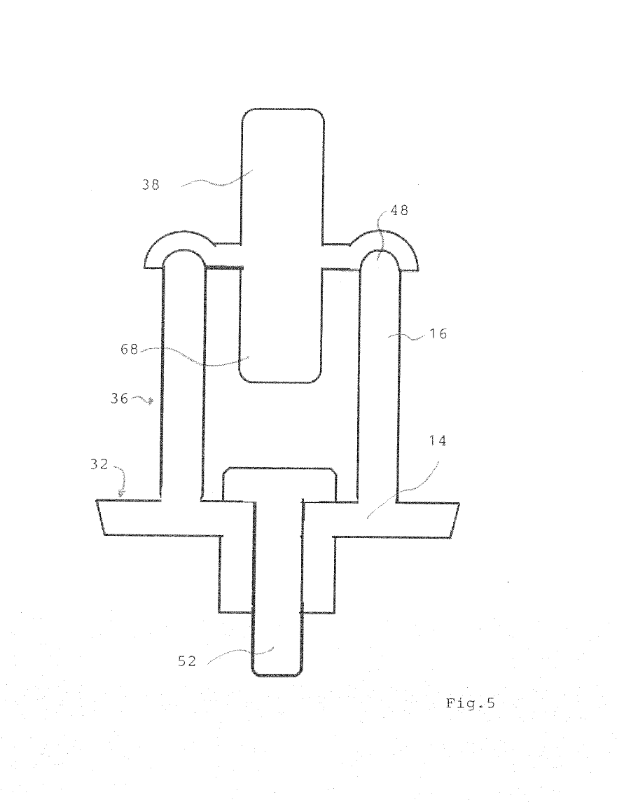

FIG. 5 shows a further illustration of a further embodiment of an inventive abutment tool set, also in the illustration according to FIG. 4;

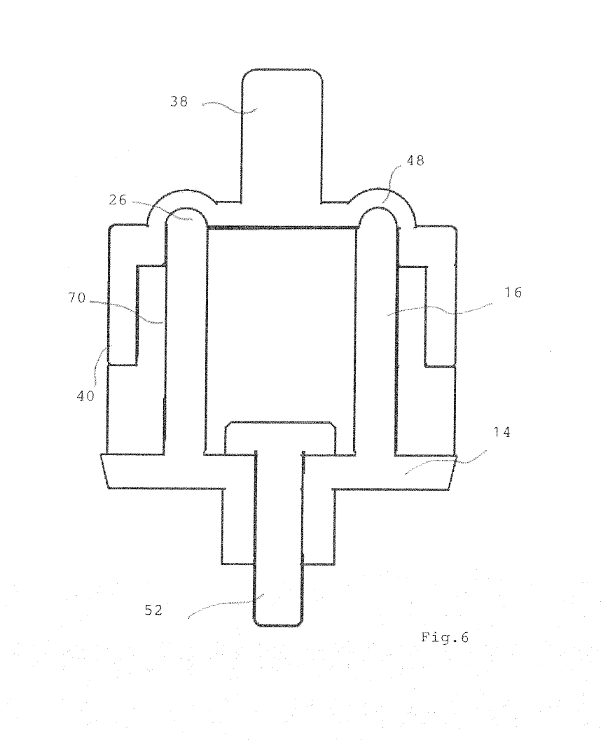

FIG. 6 shows a further illustration of a further embodiment of an inventive abutment tool set in the illustration also according to FIG. 5;

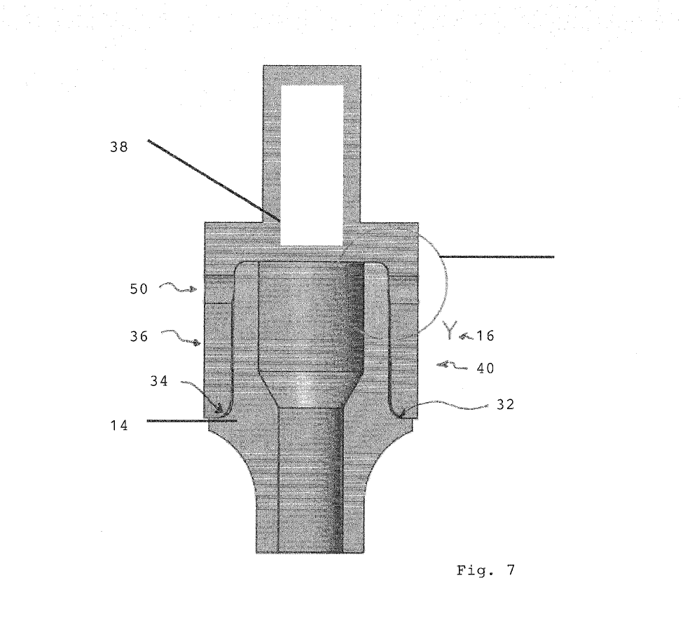

FIG. 7 shows a further illustration of a further embodiment of an inventive abutment tool set in the illustration also according to FIG. 6;

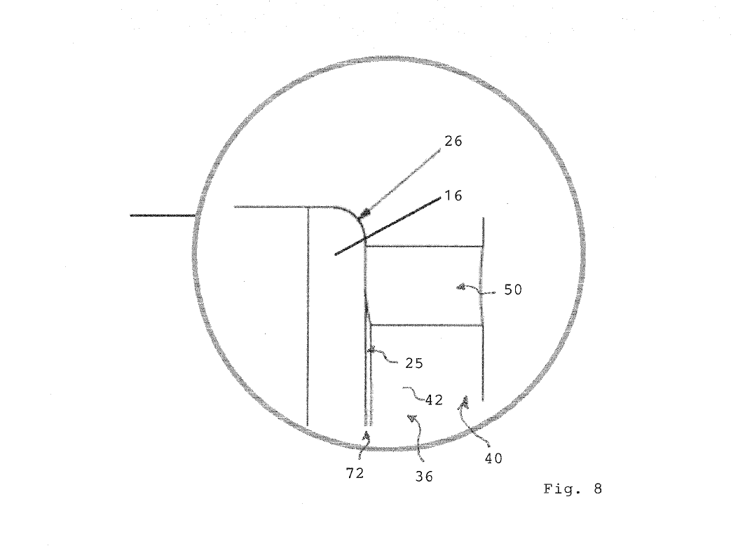

FIG. 8 shows an enlarged schematic illustration of a detail of FIG. 7;

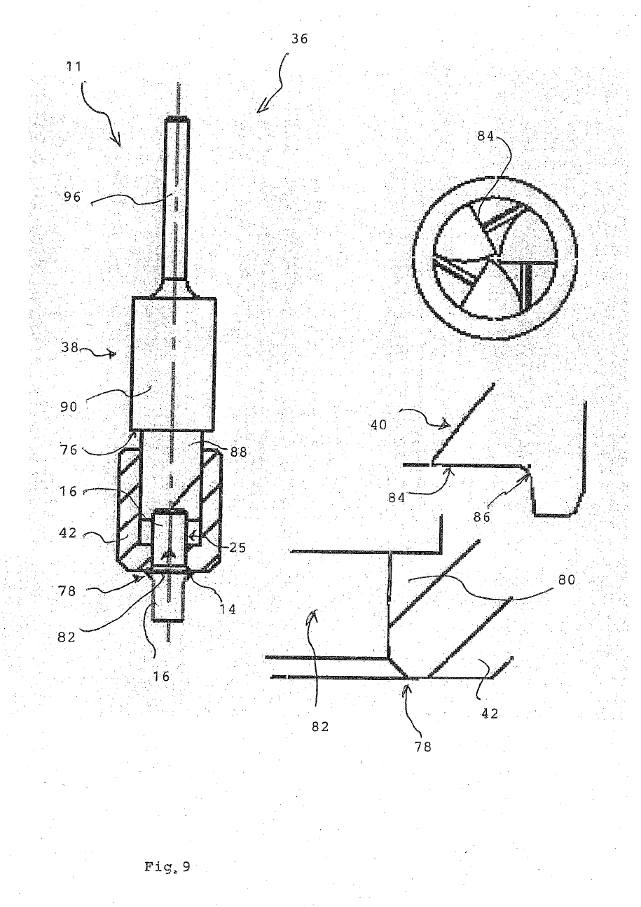

FIG. 9 shows a particularly preferable embodiment of an inventive abutment tool set; and

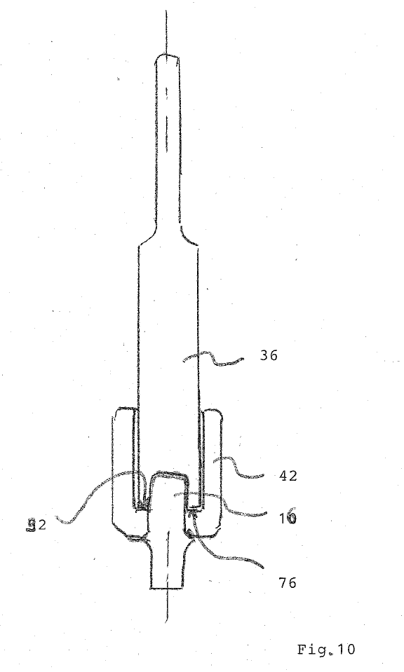

FIG. 10 shows a modified embodiment of an inventive abutment tool set.

The abutment 10 illustrated in FIG. 1 comprises an implant connection area 12 which extends in the cervical direction and ends at a collar 14. The collar transitions into a tube portion 16 via internal radii, said tube portion being intended to receive and hold the suprastructure.

The tube portion 16 comprises a groove 18 as an anti-rotation mechanism extending radially towards the inside. When using the abutment for an individual restoration such as a crown the groove 18 prevents unintentional rotation and thus serves as an anti-rotation mechanism. A corresponding flange which fits into the groove 18 is configured in the suprastructure accordingly in that case.

When the abutment is used for an abutment tooth of a bridge, the groove 18 maintains the shape illustrated herein. However, there is no flange which would engage the groove 18, on the inner side of the suprastructure. In this way, the anti-rotation mechanism of the bridge can be ensured by orienting it properly to the other abutment tooth without risking torsional stress.

The tube portion 16 ends in the area of its front face 22. At the same time, the inlet opening of the tube portion 16 forms a channel 24 for the implant screw not illustrated in FIG. 1.

From FIG. 2 a basic sectional illustration of the abutment 10 is apparent. Standard heights “L”, “M” and “S” are marked to which the tube portion 16 of the abutment can be shortened. As can be seen, the groove 18 extends also below the standard height “S” such that the anti-rotation mechanism is also ensured when the abutment 10 is shortened to the height S.

As can be seen from FIG. 2, the transition between the front face 22 and the external surface 25 of the tube portion 16 is rounded with a radius 26. The size of this radius 26 can be adapted to the requirements to a large extent; it typically amounts to between 0.05 mm and 1.0 mm, and preferably to about 0.2 mm. This external radius 26 surprisingly improves the durability of the suprastructure considerably; obviously, the external radius 26 greatly equalizes the maximum local introduction of forces into the suprastructure.

As can be seen, the collar 14 comprises a circularly circumferential bearing area 32 which extends vertically relative to an axis 30 of the abutment. Via a fillet radius 34 the bearing surface 32 transitions into the external surface 25 of the tube portion 16.

According to the invention—as can be seen from FIG. 3—it is provided to effect the shortening of the tube portion 16 of the abutment 10 by means of an abutment tool set 11 with a milling cutter 36 illustrated in FIG. 3. The basic cross-sectional shape of the milling cutter 36 is configured like an annular bit. It comprises a shank 38 whose external diameter is suitable for being driven by any desired mechanical tool available in the dental practice or generally in the dental field. For this purpose, the shank diameter amounts to, for instance, 2.35 mm or 3 mm at the clamping or actuation area.

The bell-shaped element 40 of the milling cutter 36 comprises a cylindrical portion or a sleeve 42 whose internal diameter fits the external surface 25 of the tube portion 16 of the abutment 10 in a minimum clearance fit. The cylindrical portion extends at the bottom up to the bearing surface 32 of the collar 14 which serves as a dimensioning reference.

The milling cutter 36 illustrated herein is intended to shorten the abutment 10 to the height “L”. For this purpose, at the outer areas of its front face 46 it comprises a fillet 48 which is provided with cutting edges and in this respect with teeth. When turning the milling cutter 36 via the shank 38 the abutment 10 is shortened in a machining process thereat, for as long as the cylindrical portion contacts the bearing surface 32. For the milling operation, the front face 46 may comprise staggered or single-edged teeth, for a grinding operation it can be equipped with diamonds.

As can be seen from FIG. 3 chip removal recesses 50 are distributed evenly around the circumference of the milling cutter 36, namely just under the front face 46 at the cylindrical sleeve 42.

As can also be seen from FIG. 3 an implant screw 52 extends through the abutment 10 towards the bottom; it serves to be anchored in the associated implant in a way known per se.

It is to be understood that for the three heights “L”, “M” and “S” of the tube portion 16 three correspondingly sized sleeves 42 are provided. Their configuration at the fillet 48 with an internal radius ensures that the external radius 26 (see FIG. 2) is maintained even if the tube portion 16 is shortened.

A further configuration of the abutment tool set 11 is apparent from FIG. 4. Here, just like in the further Figures, the same reference numerals indicate the same parts. The abutment tool set 11 according to FIG. 4 comprises a stop pin 60 which is intended to rest on the implant screw 52. The stop pin 60 extends from an internal cylinder 62 of the abutment tool set 11 to the implant screw 52 such that the height stop of the abutment tool set 11 is additionally limited by the implant screw 52.

In a further advantageous embodiment (not illustrated herein) it is provided that the bell-shaped element 40 of the abutment tool set 11 comprises marks at the cylindrical portion 42. While the maximum length of the bell-shaped element 40 corresponds to the height “L” in this case, a mark is provided which corresponds to the height “M” and a further mark is provided which corresponds to the height “S”. If necessary, the dentist or dental technician can now shorten the cylindrical portion to “M” or even to “S” and can then effect the desired shortening of the tube portion 16 of the abutment 10 either to “L”, to “M” or to “S”, without any additional stock-keeping.

According to the invention it is completely uncritical that the manual shortening process of the bell-shaped element 40 might not be carried out in optimum quality as the fillet 48 which determines the shape always remains untouched by the shortening process such that the abutment 10 can also be produced in perfect quality according to the invention.

A modified embodiment of the abutment tool set 11 is apparent from FIG. 5. Instead of the bell-shaped element 40 it comprises an internal element 66 which is intended for insertion into the tube portion 16. The internal element 66 is connected to the shank 38 via a connection pin 68, and the abutment tool set 11 equally comprises the fillet 48 for providing the shape of the external radius of the tube portion 16.

The shape of the internal element 66 equally ensures a height stop, however, not on the bearing surface 32 but on the implant screw 52.

From FIG. 6 another embodiment of an inventive abutment tool set 11 is apparent. Instead of the internal element an external element 70 is provided thereat which extends subsequently to the shortened bell-shaped element 40 towards the bottom and which rests on the bearing surface 32 of the collar 14. Here, too, a fillet 48 is provided in the same manner to provide for the external radius 26 of the tube portion 16.

From FIG. 7 a further embodiment of an inventive abutment tool set 11 is apparent. Again, the external/bottom side of the bell-shaped element 40 ends on the bearing surface 32 of the collar 14. It comprises a spherical configuration corresponding to the radius 34 of the transition between the tube portion 16 and the collar 14.

FIG. 8 shows a detailed view of the part Y of FIG. 7. The external radius 26 is clearly shown which is produced by the fillet 48 of the milling cutter 36 at the tube portion 16.

The cylindrical portion 42 of the bell-shaped element 40 of the abutment tool set 11 comprises a small amount of play 72 with respect to the external surface 25 of the tube portion 16 such that no or at most minimum friction is produced during the machining process.

In FIG. 9 a preferred embodiment of the inventive abutment tool set 11 is illustrated. The abutment tool set 11 is a two-piece tool set in this embodiment and consists of a milling cutter 36 and of a sleeve 42 which receives and guides the milling cutter. For this purpose, the milling cutter 36 at least partially reaches into the sleeve 42. The sleeve 42 is U-shaped in cross-section. It comprises a guide hole 82 whose internal diameter fits the external diameter of the tube portion 16 of the abutment and which is guided at the external surface 25 of the tube portion 16. In this respect, the base 80 of the sleeve 42 comprises the guide hole 82 centrally. The base 80 also forms a supporting face 78 which is configured to be supported on the collar 14 of the abutment 10.

Furthermore, the milling cutter 36 comprises a step between a work portion 88 and a transition area 90. The transition area 90 has a larger diameter than the work portion 88, and the transition forms an abutment face 76. This abutment face rests on the sleeve 42 when the milling operation of the milling cutter is finished.

Thus, the height of the sleeve 42 determines the exact target height of the tube portion 16 of the abutment 10.

The shank 38 of the milling cutter 36 consists of a clamping and actuation area 96 besides the transition area 90. This clamping and actuation area has a smaller diameter than the transition area 90 and is either intended to be clamped into a dental milling machine or to be actuated manually.

The enlarged detailed view of the milling cutter 36 shows that the milling cutter comprises cutting edges 84 which extend towards the bottom beyond the fillet 86. In this respect, this part of the milling cutter 36 also forms a bell-shaped element 40 in turn.

FIG. 10 illustrates a modified embodiment of an inventive tool set. In this embodiment, the abutment face 76 is shifted to the bottom. At the same time, the abutment face 76 is the front face of the milling cutter 36 and surrounds the tube-shaped portion 16. Upon contact with the base 92 of the sleeve 42, the target height is reached, wherein the milling cutter 36 is configured in a bell-shaped manner and can comprise a three-point milling cutter for shortening the tube-shaped portion 16 at specific positions, as has already been described in connection with FIG. 9.

In order to keep friction with respect to the sleeve 42 low the milling cutter 36 is guided in the sleeve 42 with clearance.

While the inventive abutment tool set is preferably configured as a manual milling cutter it is possible alternatively to realize the tool set as a mechanical tool in the course of the CAM production.

1. An abutment tool set for dental abutments, characterized in that the tool set consists of a milling cutter (36) and a sleeve (42), and that at least one abutment face (76) is formed on the milling cutter which extends towards the sleeve (42), and that the sleeve (42) has a supporting face (78), for supporting on an abutment (10).

2. The abutment tool set as claimed in claim 1, characterized in that, the sleeve (42) is separate from the milling cutter (36) and is configured as an exchangeable part, and that the milling cutter (36) can be inserted partially into the sleeve and has an external diameter thereat which fits the internal diameter of the sleeve (42), in a clearance fit.

3. The abutment tool set as claimed in claim 1, characterized in that the sleeve (42) has a base (80) comprising a guide hole (82), wherein said guide hole (82) can be pulled over a tube-shaped portion (16) of the abutment (10), and that the sleeve (42) supports the milling cutter (36) on a collar (14) of the abutment (10).

4. The abutment tool set as claimed in claim 1, characterized in that the milling cutter (36) is configured as a multi-point milling cutter and that the milling cutter (36) overlaps the tube-shaped portion (16) of the abutment (10) from the top.

5. The abutment tool set as claimed in claim 1, characterized in that cutting edges (84) of the milling cutter (36) configure a fillet (86) which mill a corner radius of the tube-shaped portion (16) of the abutment (10).

6. The abutment tool set as claimed in claim 1, characterized in that the milling cutter (36) comprises a work portion (88) and a shank (38), and that the work portion (88) transitions to the shank (38) via the abutment face (76) and comprises a height which is smaller than the height of the sleeve (42) starting from the base (80).

7. The abutment tool set as claimed in claim 1, characterized in that the sleeve (42) has a larger friction with respect to the tube-shaped portion (16) of the abutment (10) than with respect to the milling cutter (36).

8. The abutment tool set as claimed in claim 1, characterized in that a tube-shaped portion (16) of the abutment (10) comprises marks in accordance with target heights of the tube-shaped portion (16).

9. The abutment tool set as claimed in claim 1, characterized in that the milling cutter (36) is configured as a manual milling cutter or as a mechanical milling cutter.

10. A device for producing tooth replacements, in which the tooth replacement comprises an implant and an abutment (10) on which or to which a dental structure made of a dental material, which is produced by means of constructing methods or removing methods, can be attached, wherein the abutment (10) is mounted to the implant in by means of a releasable connection, wherein the abutment (10) comprises an implant connection (12) and a tube portion (16), between which a collar (14) extends which protrudes to the outside, characterized in that the device for producing dental replacements has a milling cutter (36) for shaping the front face of the tube portion (16), which milling cutter (36) has at least one abutment face which is intended to bear at least indirectly on a surface of the abutment (10), and via which milling cutter (36) the length or height of the tube portion (16) of the abutment (10) can be determined.

11. The device for producing dental replacements as claimed in claim 10, characterized in that the milling cutter (36) comprises a sleeve (42) as a height stop element which limits the milling motion when milling the tube-shaped portion (16) of the abutment (10), said sleeve (42) forming a stop with respect to a collar (14) of the abutment.

12. The device for producing dental replacements as claimed in claim 10, characterized in that the milling cutter (36) forms a bell-shaped element (40) whose front face comprises a fillet (84) which is intended to shape the front face of the tube portion (16).

13. The device for producing dental replacements as claimed in claim 10, characterized in that the milling cutter (36) comprises a bell-shaped element (40), and that a sleeve (42) surrounds the bell-shaped element and comprises plastic.

14. The device for producing dental replacements as claimed in claim 10, characterized in that the sleeve (42) comprises at least one chip removal recess (50) which is adjacent to a front face of a bell-shaped element (40) of the milling cutter (36).

15. The device for producing dental replacements as claimed in claim 10, characterized in that the abutment face (76) is configured on a front face of the milling cutter (36) and is intended for abutting on a base (94) of the sleeve (42).

16. The abutment tool set as claimed in claim 4, characterized in that the multi-point milling cutter comprises a three-point milling cutter

17. The abutment tool set as claimed in claim 8, characterized in that the marks comprise three marks in accordance with target heights S, M and L of the tube-shaped portion (16).

18. The device for producing tooth replacements as claimed in claim 10, in which the dental material comprises ceramic.

19. The device for producing tooth replacements as claimed in claim 10, in which the constructing methods comprises Rapid Prototyping.

20. The device for producing tooth replacements as claimed in claim 10, in which the removing methods comprise milling by means of CAM.

21. The device for producing tooth replacements as claimed in claim 10, wherein the releasable connection comprises a screwed connection.

22. The device for producing tooth replacements as claimed in claim 10, wherein the surface of the abutment in which the milling cutter (36) has at least one abutment face which is intended to bear at least indirectly on a surface of the abutment (10) comprises the collar (14) of the abutment.

23. The device for producing tooth replacements as claimed in claim 10, wherein via milling cutter (36) the tube portion (16) of the abutment (10) can be shaped.
